(19) United States
(12) Patent Application Publication
(10) Pub. No.: US 2006/0206571 A1
(43) Pub. Date: Sep. 14, 2006

(54) System and method for URL risk assessment, and computer product

(75) Inventor: Soichi Kuwahara, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/192,139

(22) Filed: Jul. 29, 2005

(30) Foreign Application Priority Data
Mar. 14, 2005 (JP) 2005-071986

(51) Int. Cl. G06F 15/16

(52) U.S. Cl. 709/206

(57) ABSTRACT

A client device requests a server device to assess a risk of a URL included in an email received. The server device stores the URL for which the request was received, in correspondence with the user information, in a storage unit. Risk of the URL is assessed based on whether other client devices received the same URL, by referring to the information stored in the storage unit. A risk assessment result is notified to the client device.

### BACKGROUND OF THE INVENTION

1. Field of the Invention

The present invention relates to a system and method for uniform resource locator (URL) risk assessment, and a computer product that assess a risk of a URL included in an email received by a client device.

2. Description of the Related Art

Conventionally, there is a problem of unsolicited emails, which include a URL embedded as a hyperlink, and are sent to many unspecified users. Some of the unsolicited emails are embedded with a URL that links to a destination email address. When a receiver accesses the URL included in the unsolicited email, there is a possibility that distributors of the unsolicited emails obtain personal information of the receiver, such as the validity of the destination email address, interests, and time of accessing the Internet.

Recently, “Material 5 in explanatory material made by secretariat on a study meeting relating to response to unsolicited emails (stored by the Ministry of Internal Affairs and Communications on October 22 (Fri), 2004)”discloses a countermeasure in which a user using a terminal device sets rejection to an email address of a sender of an unsolicited email, or registers rejection to such emails at the mail server, so that an unsolicited email having the email address is not received in the future. There is another countermeasure in which users or providers register the URL embedded in unsolicited emails or the like, and other dangerous URLs in the server, so that the URL is checked at the time of accessing the URL.

However, in the conventional technique, even if reception rejection is set with respect to the sender address of an unsolicited email, or if the URL included in the unsolicited email is registered with the mail server for reception rejection, unsolicited emails sent one after another by changing the sender address, or by changing the URL cannot be prevented, for example, unsolicited email distributors can create email addresses and URLs easily and in large quantities by using an automatic generation tool of a computer. Consequently, there is no effect in preventing inadvertent access to the URL.

### SUMMARY OF THE INVENTION

It is an object of the present invention to at least solve the problems in the conventional technology.

According to an aspect of the present invention, a URL risk assessment system that assesses a risk of a URL included in an email that is received by a client device, includes a URL information storage unit that stores the URL in correspondence with user information, where the user information identifies any one of the client device that received the email, and the user that received the email; and a URL risk assessing unit that assesses the risk of the URL based on whether other client devices have received the same URL, by referring to the user information stored.

According to another aspect of the present invention, a URL risk assessment system includes a client device; and a server device that assesses a risk of a URL included in an email received by a client device, where the client device includes a URL risk assessment requesting unit that sends a request to perform the URL risk assessment, and the URL included in the email, to the server device, and the server device includes a URL information storage unit that stores the URL for which a request for risk assessment is received, in correspondence with the user information for identifying the client device that sent the request, a URL risk assessing unit that assesses the risk of the URL based on whether other client devices have received a same URL, identical to the URL for which the request for risk assessment is received, by referring to the user information stored, and a URL risk notifying unit that notifies the client device of a URL risk assessment result.

According to still another aspect of the present invention, a first method for assessing a risk of a URL included in an email that is received by a client device, includes storing the URL in correspondence with user information, where the user information identifies any one of the client device that received the email, and the user that received the email; and assessing the risk of the URL based on whether other client devices have received the same URL, by referring to the user information stored.

According to still another aspect of the present invention, a computer-readable recording medium that stores therein, a computer program for assessing a risk of a URL included in an email that is received by a client device, the computer program including instructions, which when executed, cause the computer to execute the first method.

According to still another aspect of the present invention, a second method of URL risk assessment in which a server device assesses a risk of a URL included in an email received by a client device, includes sending, from the client device to the server device, a request to perform the URL risk assessment, and the URL included in the email; storing, in the server device, the URL for which a request for the URL risk assessment is received, in correspondence with the user information for identifying the client device that sent the request; assessing the risk of the URL based on whether other client devices have received a URL identical to the URL for which the request for risk assessment is received, by referring to the user information stored at the storing, where the assessing is executed by the server device; and notifying the client device of a URL risk assessment result, the notifying being executed by the server device.

According to still another aspect of the present invention, a computer-readable recording medium that stores therein, a computer program for performing URL risk assessment in which a server device assesses a risk of a URL included in an email received by a client device, the computer program including instructions, which when executed, cause the computer to execute the second method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts an outline of a URL risk assessment system according to a first embodiment;

FIG. 2 is one example of an email address-URL correspondence table according to the first embodiment;

FIG. 3 is one example of an unsolicited email according to the first embodiment;

FIG. 4 is a block diagram of a configuration of the URL risk assessment system according to the first embodiment;

FIG. 5 depicts information stored in a server device according to the first embodiment;

FIG. 6 is a flowchart of a URL risk assessment process according to the first embodiment;

FIG. 7 is a block diagram of a configuration of a client device according to the first embodiment;

FIG. 8 is a flowchart of a process executed by the client device until reception of a URL risk assessment result, according to the first embodiment;

FIG. 9 depicts contents of an email created automatically when the client device according to the first embodiment requests for URL risk assessment;

FIG. 10 depicts contents of an email notifying the client device of the URL risk assessment result, according to the first embodiment;

FIG. 11 is a block diagram of a configuration of a URL risk assessment system according to a first modification of a second embodiment;

FIG. 12 depicts a relation between phone numbers, Internet protocol (IP) addresses, base station IDs, and corresponding URLs according to a third modification of the second embodiment;

FIG. 13 depicts a situation in which ex-post confirmation of safety of a URL is performed, according to a fourth modification of the second embodiment;

FIG. 14 depicts a situation in which a client device automatically accesses the URL upon reception of a URL risk assessment result, according to a sixth modification of the second embodiment;

FIG. 15 is a block diagram of a configuration of the client device according to a seventh modification of the second embodiment;

FIG. 16 depicts a computer that executes a URL risk assessment program; and

FIG. 17 depicts a computer that executes a URL risk assessment request program.

### DETAILED DESCRIPTION OF THE PREFERRED EMBODIMENTS

Exemplary embodiments of the present invention will be explained below with reference to the accompanying drawings. Other embodiments included in the present invention will be explained as a second embodiment.

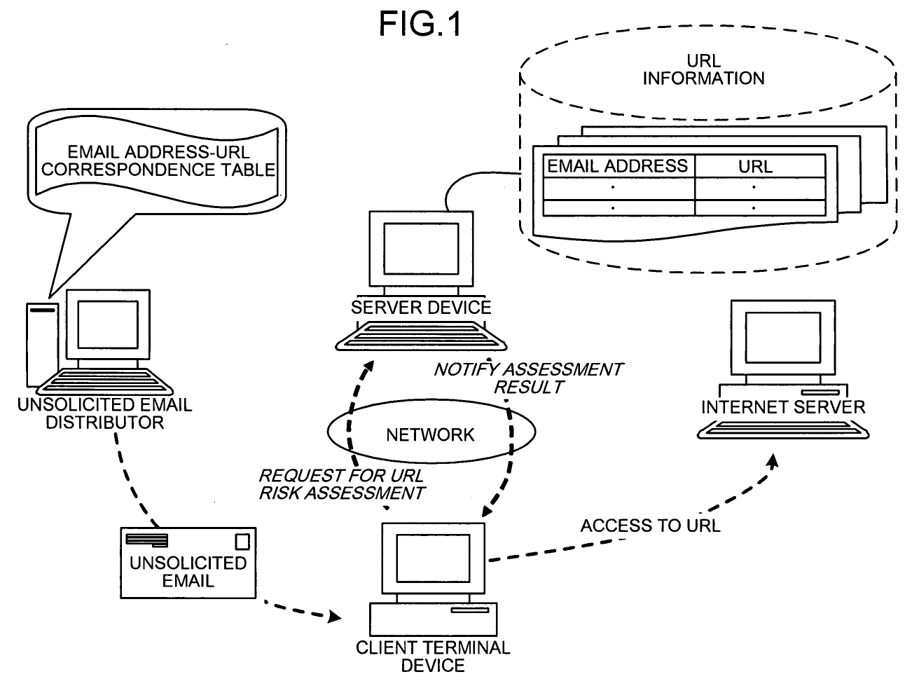

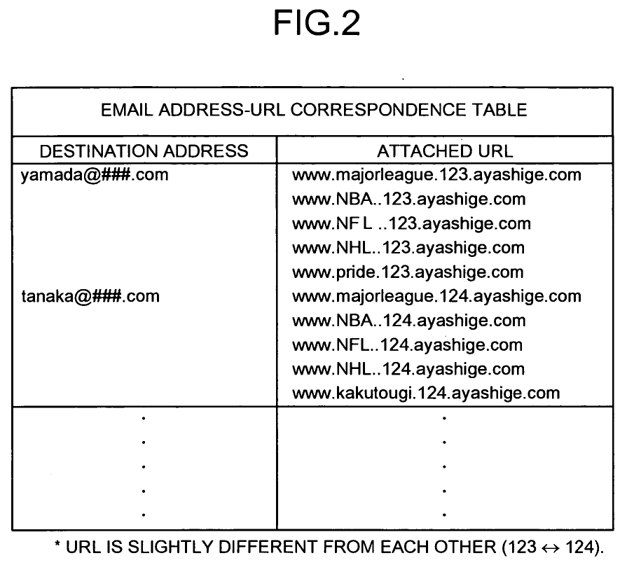

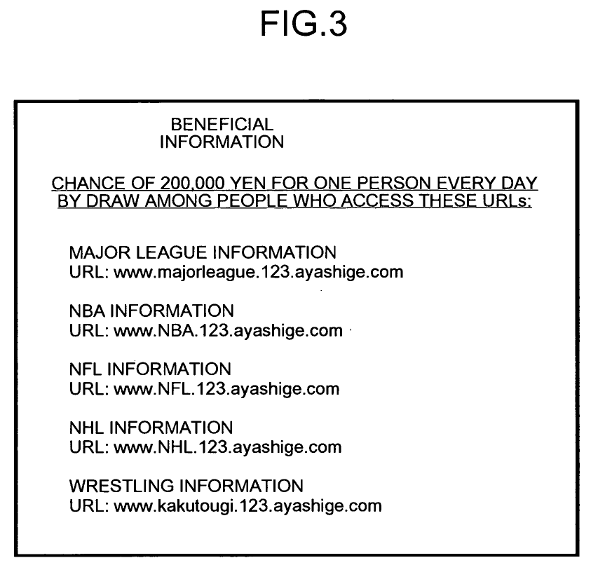

An outline and the characteristics of a URL risk assessment system according to a first embodiment will be explained first with reference to FIGS. 1 to 3. FIG. 1 depicts the outline of the URL risk assessment system according to the first embodiment, FIG. 2 is one example of an email address-URL correspondence table according to the first embodiment, and FIG. 3 is one example of an unsolicited email according to the first embodiment.

As shown in FIG. 1, the URL risk assessment system according to the first embodiment includes client devices and a server device connected via a network (communication network formed of public telephone networks, the Internet, local area network (LAN) and wide area network (WAN)), in a mutually communicable state. The URL risk assessment system assesses the risk of a URL included in emails received by the client devices.

Specifically, an unsolicited email distributor sends unsolicited emails that include a URL (for example, see FIG. 3) to many and unspecified users. Such unsolicited emails are.managed through an email address-URL correspondence table (for example, see FIG. 2) stored by the unsolicited email distributor. Therefore, when a user receives the unsolicited email and accesses the URL included in the unsolicited email, the unsolicited email distributor obtains personal information such as the validity of the destination email address, interests of the user, and time of access.

The outline of the URL risk assessment system according to the first embodiment is the assessment of the risk of the URL included in such an unsolicited email, but the main characteristic of the URL risk assessment system is that the server device assesses the URL risk upon receiving a request from the client device.

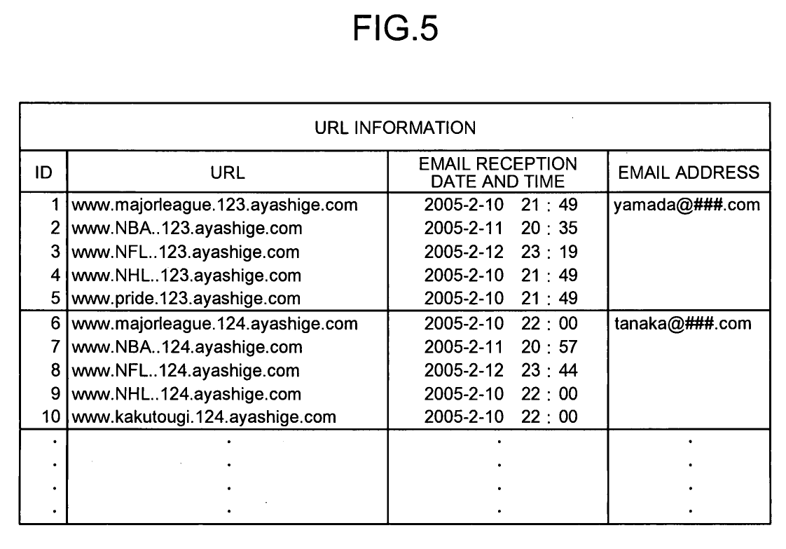

To briefly explain the characteristic, the server device receives a request for URL risk assessment from a client device that receives an unsolicited email containing a URL. The server device stores the URL received from the client device in correspondence with user information (for example, see FIG. 5). The server device then assesses the URL risk depending on whether other client devices have received the same URL, by referring to the information stored. For example, when other client devices have received the same URL, the server device assesses that the risk is low, because an individual is difficult to be identified. Subsequently, the server device informs the client device of the URL risk assessment result. Thus, a user of the client device can determine whether to access the URL, based on the URL risk assessment result informed from the server device.

According to the URL risk assessment system, therefore, the risk of the URL included in the unsolicited email is assessed based on whether other client devices have received the same URL. Hence, the URL risk assessment system can handle unsolicited emails sent one after another even if the sender address, or the URL has been changed, thereby preventing inadvertent access to the URL. Accordingly, the unsolicited email distributor is prevented from obtaining personal information such as the validity of the email address, interests, and time of accessing the Internet.

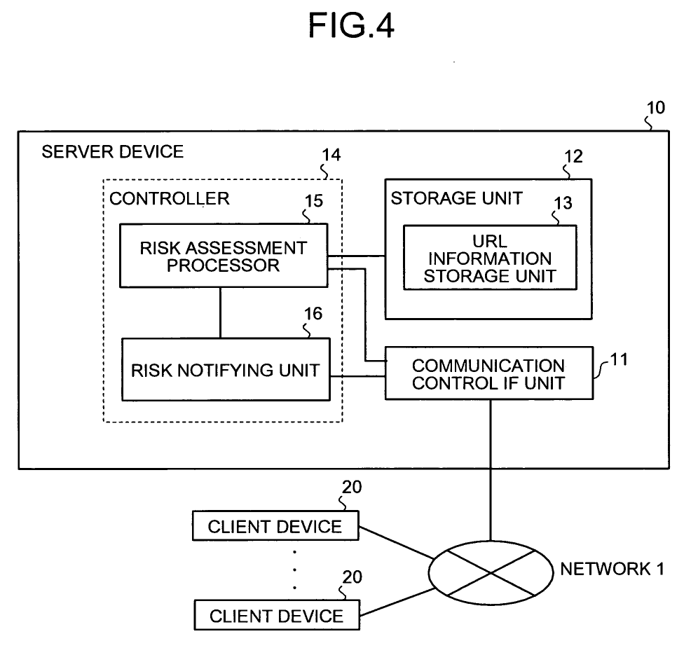

A configuration of the server device according to the first embodiment will be explained with reference to FIGS. 4 and 5. FIG. 4 is a block diagram of the configuration of the URL risk assessment system according to the first embodiment, and FIG. 5 depicts the information stored in a user information storage unit according to the first embodiment.

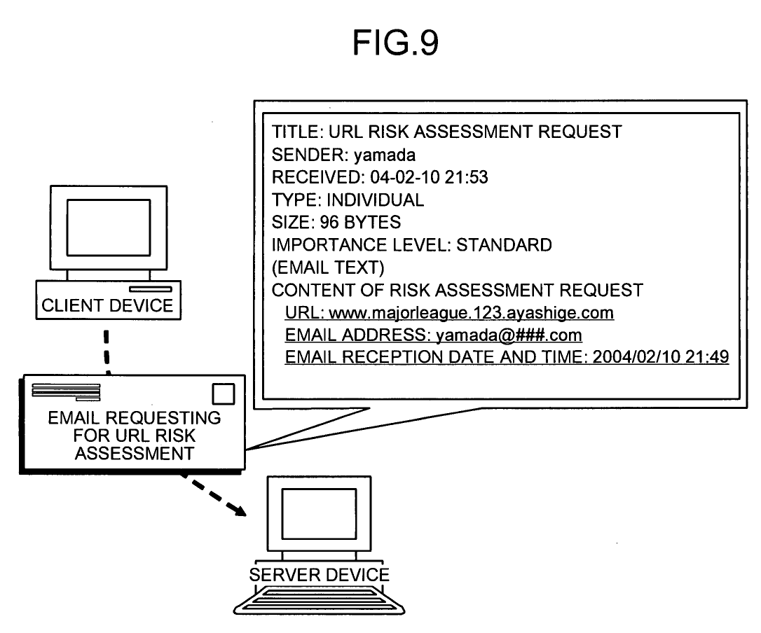

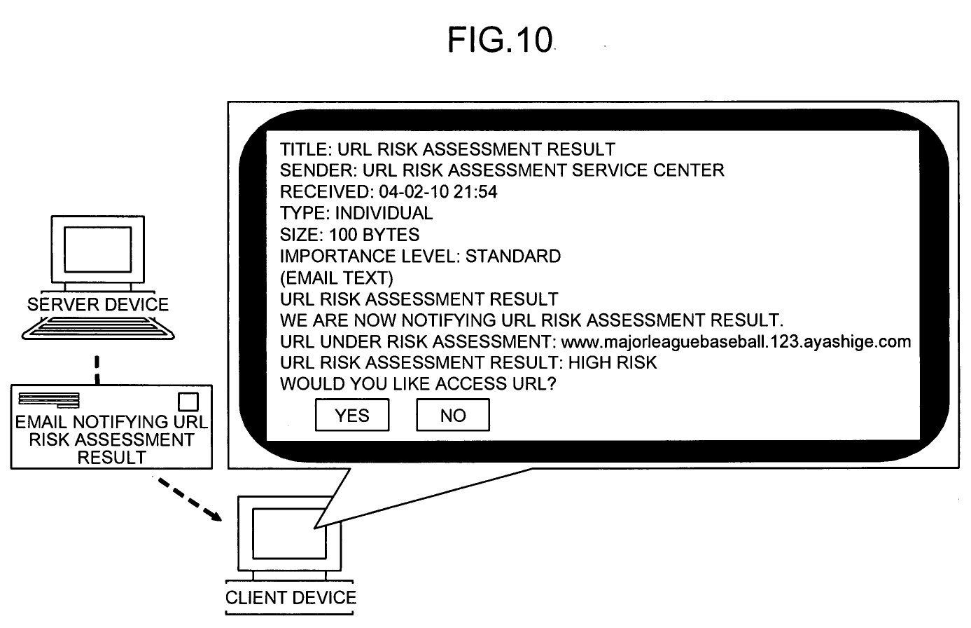

As shown in FIG. 4, a server device 10 includes a communication control interface (IF) unit 11, a storage unit 12, and a controller 14 connected via a predetermined bus or the like. The communication control IF unit 11 controls the communication between a client device 20 and the server device 10. For example, the communication control IF unit 11 receives a URL risk assessment request (for example, see FIG. 9) from the client device 20, and transmits a URL risk assessment result (for example, see FIG. 10) to the client device 20.

The storage unit 12 stores data used for various kinds of processes in the controller 14. As shown in FIG. 4, the storage unit 12 includes a URL information storage unit 13, which is closely related to the present invention. The URL information storage unit 13 is a database for storing information received from the client device 20 via a network 1, and specifically, stores a URL received from the client device 20, date and time of receiving an unsolicited email, and an email address of the client device in correspondence with one another. The URL information storage unit 13 corresponds to a “URL information storage unit” described in claims.

The controller 14 executes various kinds of processes by controlling the server device 10, and includes a risk assessment processor 15 and a risk notifying unit 16, which are closely related to the present invention. The risk assessment processor 15 corresponds to a “URL risk assessing unit” in the claims, and the risk notifying unit 16 corresponds to a “URL risk notifying unit” in the claims.

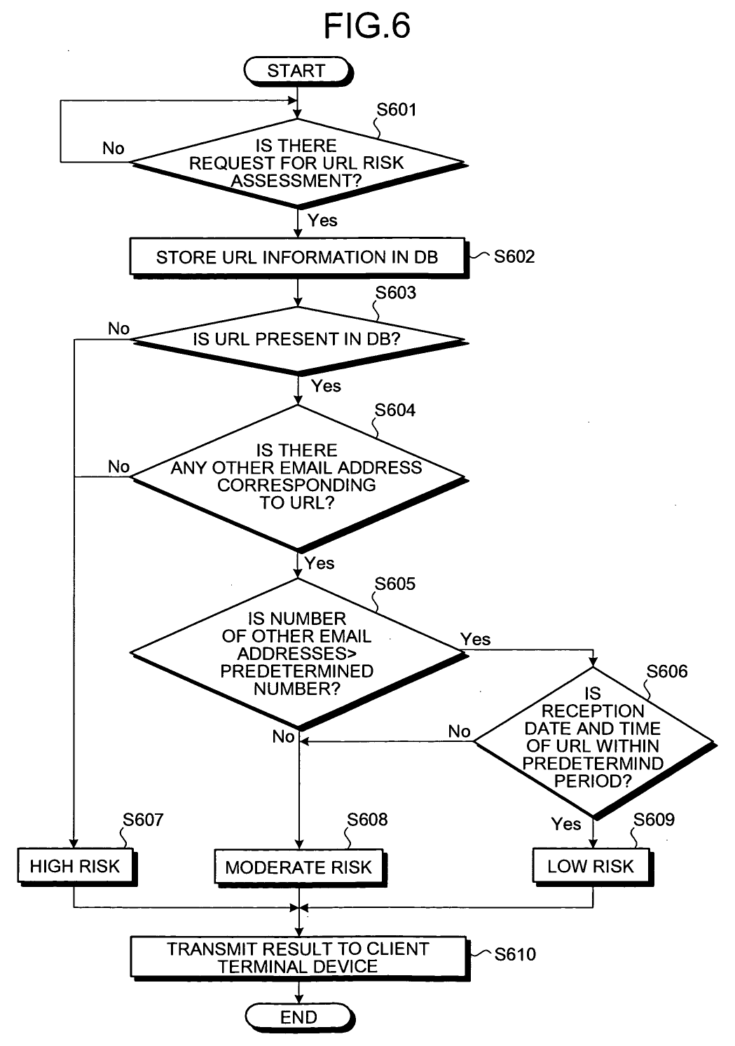

In the controller 14, the risk assessment processor 15 performs URL risk assessment for a URL requested from the client device 20, based on the information in the URL information storage unit 13. Specifically, upon receiving a request for the URL risk assessment from the client device, the risk assessment processor 15 reads all data from the URL information storage unit 13, and performs URL risk assessment based on whether there is another email address of a client device that received the same URL, other than the email address of the client device that requested the URL risk assessment. The URL risk assessment process will be explained in detail with reference to the flowchart shown in FIG. 6.

The risk notifying unit 16 notifies the client device 20 of the URL risk assessment result output by the risk assessment processor 15, via the communication control IF unit 11. Specifically, the risk notifying unit 16 receives the URL risk assessment result from the risk assessment processor 15, and transmits the URL risk assessment result to the client device 20 via the communication control IF unit 11.

The server device 10 is a computer that performs various kinds of processes in response to the URL risk assessment request received from the client device 20 via the network 1. For example, the computer may be a personal computer (PC) or a workstation that includes the functions of various units described above.

The URL risk assessment process according to the first embodiment will be explained with reference to FIG. 6. FIG. 6 is a flowchart of the URL risk assessment process according to the first embodiment.

As shown in FIG. 6, upon receiving a URL risk assessment request from the client device 20 (Yes at step S601), the server device 10 stores into the URL information storage unit 13, the URL, the reception date and time of the unsolicited email, and the email address of the client device 20, received from the client device 20, in correspondence to one another (step S602). The risk assessment processor 15 reads all data from the URL information storage unit 13, and starts the risk assessment. That is, the risk assessment processor 15 looks for the same URL as the one requested for the risk assessment from the client device 20 (step S603).

If the same URL is not found in the data read (step S603), the risk assessment processor 15 sends an assessment result indicating high risk, to the risk notifying unit 16 (step S607). The risk notifying unit 16 transmits the assessment result indicating high risk to the client device 20 via the communication control IF unit 11 (step S610), and the server device 10 ends the URL risk assessment process.

On the contrary, if the same URL is found in the data read (Yes at step S603), the risk assessment processor 15 determines whether the email address stored in correspondence to the URL differs from the email address of the client device that requested the risk assessment (step S604). If the email address is not different (No at step S604), the risk assessment processor 15 outputs the assessment result indicating high risk to the risk notifying unit 16 (step S607). The risk notifying unit 16 transmits the assessment result indicating high risk to the client device 20 via the communication control IF unit 11 (step S610), and the server device 10 ends the URL risk assessment process.

On the contrary, if a different email address, other than the email address of the client device that requested the risk assessment, is found (Yes at step S604), the risk assessment processor 15 determines whether a number of the different email addresses is equal to or more than a predetermined number (step S605). If the number of the different email addresses is not equal to or more than the predetermined number (No at step S605), the risk assessment processor 15 outputs the assessment result indicating moderate risk, to the risk notifying unit 16 (step S608). The risk notifying unit 16 transmits the assessment result indicating moderate risk to the client device 20 via the communication control IF unit 11 (step S610), and the server device 10 ends the URL risk assessment process.

On the contrary, if the number of the different email addresses is equal to or more than the predetermined number (Yes at step S605), the risk assessment processor 15 determines whether the reception date and time of the URL is within a predetermined period (step S606). If the reception date and time of the URL is not within the predetermined period (No at step S606), the risk assessment processor 15 outputs the assessment result indicating moderate risk, to the risk notifying unit 16 (step S608). The risk notifying unit 16 transmits the assessment result indicating moderate risk to the client device 20 (step S610), and the server device 10 ends the URL risk assessment process.

On the contrary, if the reception date and time of the URL is within the predetermined period (Yes at step S606), the risk assessment processor 15 outputs the assessment result indicating low risk to the risk notifying unit 16 (step S609). The risk notifying unit 16 transmits the assessment result indicating low risk to the client device 20 (step S610), and the server device 10 ends the URL risk assessment process.

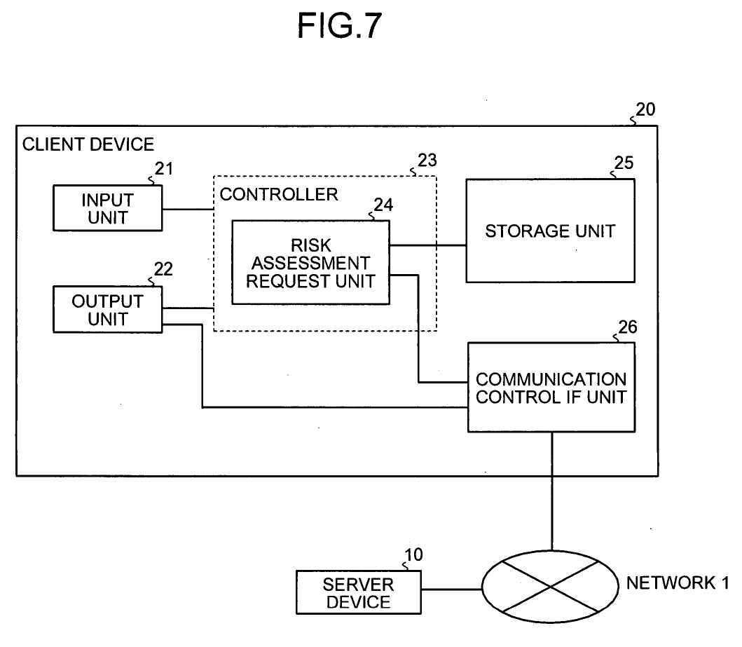

The configuration of the client device 20 according to the first embodiment will be explained next, with reference to FIG. 7. FIG. 7 is a block diagram of the configuration of the client device. As shown in FIG. 7, the client device 20 includes an input unit 21, an output unit 22, a controller 23, a storage unit 25, and a communication control IF unit 26 connected by a predetermined bus or the like.

The input unit 21 inputs various types of information, and includes an operation panel, switches, buttons, and the like. The output unit 22 outputs various types of information, and includes a monitor (or a display or an operation panel), a speaker, a lamp, and the like, and for example, outputs the URL risk assessment result received from the server device 10 via the communication control IF unit 26.

The storage unit 25 stores data and programs required for various kinds of processes by the controller 23, and the communication control IF unit 26 controls communication between the server device 10 and the client device 20. For example, an email created automatically when a risk assessment request unit 24 requests for URL risk assessment is transmitted to the server device 10 via the communication control IF unit 26.

The controller 23 is a processor that has an internal memory for storing programs specifying procedures of various kinds of processes and control data, and executes various kinds of processes based on these programs and data. The controller 23 includes the risk assessment request unit 24, which is closely related to the present invention, as shown in FIG. 7. The risk assessment request unit 24 corresponds to a “URL risk assessment requesting unit” in the claims.

In the controller, the risk assessment request unit 24 is a processor that requests for URL risk assessment to the server device 10. Specifically, when the user uses the input unit 21 to instruct an access to a URL included in the unsolicited email (for example, see FIG. 3) displayed on the output unit 22, the risk assessment request unit 24 automatically creates an email (for example, see FIG. 9) describing the URL, the reception date and time of the unsolicited email, and the email address of the requesting client device. The risk assessment request unit 24 then automatically transmits this email to the server device 10 via the communication control IF unit 26.

Such a client device 20 is communication equipment accessible to the server device 10 via the network, includes the functions of the above units, and may be, for example, a PC, a workstation, a home game machine, an Internet TV, a personal digital assistant (PDA), or a mobile communication terminal such as a mobile phone or a personal handyphone system (PHS).

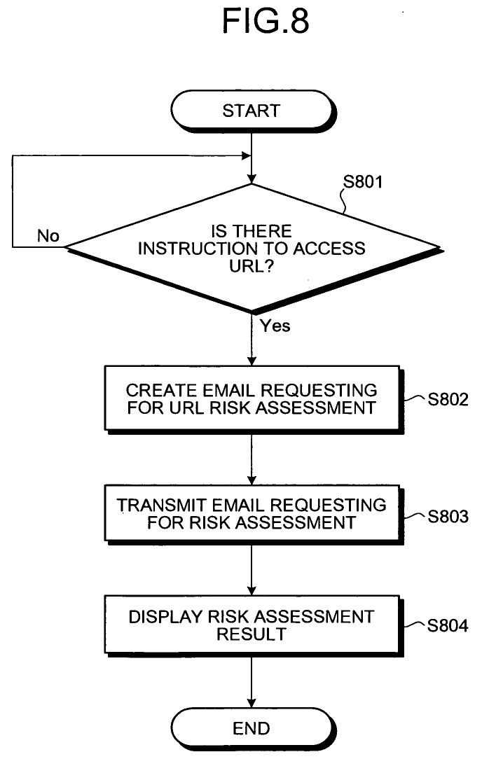

The URL risk assessment request process according to the first embodiment will be explained with reference to FIGS. 8, 9, and 10. FIG. 8 is a flowchart of a process executed by the client device until reception of a URL risk assessment result, according to the first embodiment. FIG. 9 depicts contents of an email created automatically when the client device according to the first embodiment requests for URL risk assessment. FIG. 10 depicts contents of an email notifying the client device of the URL risk assessment result, according to the first embodiment.

As shown in FIG. 8, when the user of the client device 20 instructs an access to the URL included in an unsolicited email using the input unit 21 (Yes at step S801), in a state that the unsolicited email (for example, see FIG. 3) received by the client device 20 is displayed on the output unit 22, the risk assessment request unit 24 automatically creates an email describing the URL, the reception date and time of the unsolicited email, and the email address of the requesting client device (for example, see FIG. 9) (step S802). The risk assessment request unit 24 requests the server device 10 for the URL risk assessment, by automatically sending this email to the server device 10 via the communication control IF unit 26 (step S803).

The server device 10 sends an email notifying the URL risk assessment result via the communication control IF unit 26, and the client device 20 displays the email on the output unit 22 (step S804). Specifically, as shown in FIG. 10, the URL risk assessment result is displayed on the output unit 22 in the client device 20, and the URL risk assessment request process and the assessment result reception process end.

According to the first embodiment, the risk of a URL included in the received unsolicited email is assessed based on whether other client devices have received the same URL (for example, when other client devices have received the same URL as that included in the unsolicited email, it is assessed that the risk is low). Therefore, the URL risk assessment system according to the first embodiment can handle unsolicited emails sent one after another even if the sender address or the URL is changed, thereby preventing an inadvertent access to the URL. Accordingly, the unsolicited email distributor is prevented from obtaining personal information such as the validity of the email address, interests, and time of accessing the Internet.

According to the first embodiment, URLs and user information are stored one after another in the server device that receives the URL risk assessment requests from the client devices. Therefore, in this URL risk assessment system, the URL information need not be stored separately in the server device.

According to the first embodiment, it is determined whether a number of the client devices that received the unsolicited email including the same URL, other than the client device having received the unsolicited email including the URL, is equal to or more than a predetermined number. Therefore, the user is prevented from inadvertently accessing the URL, not only when the unsolicited email distributor transmits unsolicited emails separately to plural client devices, but also when the unsolicited email distributor transmits unsolicited emails to a group of a predetermined number of client devices.

According to the first embodiment, it is determined whether the email reception date and time of the client devices that received the same URL are within a predetermined period. Therefore, the user is prevented from inadvertently accessing the URL, when the unsolicited email distributor sends unsolicited emails including the same URL to different users, with a sufficient time interval.

The URL risk assessment system according to the first embodiment has been explained above, but the present invention can be embodied in various different forms, other than the first embodiment. Therefore, various different embodiments will be explained below as the second embodiment, by dividing the embodiments into 11 modifications (1) to (11).

(1) URL Risk Assessment According to URL Information Stored in Advance in the Server Device

In the first embodiment, the URL risk is assessed according to the information stored in the server device 10, upon reception of the URL risk assessment request from the client device 20. However, the present invention is not limited thereto, and for example, information relating to a URL of high risk and a URL having no risk can be stored in advance in the server device 10, separate from the information stored at the time of requesting for the URL risk assessment, and the URL risk assessment may be preferentially executed based on the information.

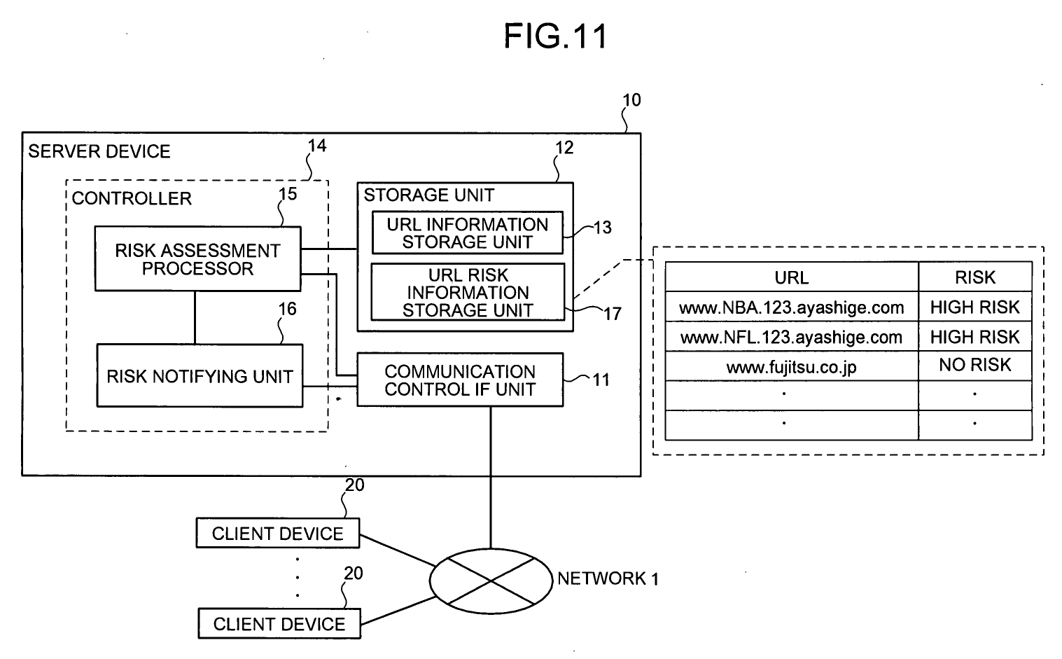

Specifically, FIG. 11 is a block diagram of the configuration of the URL risk assessment system according to modification (1) of the second embodiment. As shown in FIG. 11, the server device 10 includes a URL risk information storage unit 17 in the storage unit 12. The URL risk information storage unit 17 stores information of a high risk URL (for example, a blacklist) and information of a URL having no risk (for example, a whitelist) in advance. The risk assessment processor 15 executes the URL risk assessment by preferentially referring to the information stored in the URL risk information storage unit 17.

The risk assessment processor 15 refers to the URL information stored in the URL risk information storage unit 17. If the URL, for which the risk assessment is requested, matches the information of the URL having no risk, the risk assessment processor 15 assesses that the URL risk is low. On the other hand, if the URL matches the high risk URL, the risk assessment processor 15 assesses that the URL risk is high.

Because the URL risk assessment is performed by preferentially referring to the information of the high risk URL and the URL having no risk stored in the server device 10 in advance, there can be a case that the URL risk assessment result can be obtained before executing the risk assessment based on the information stored in the URL information storage unit, when the client device 20 requests for the URL risk assessment. As a result, this method speed-ups and improves reliability of the URL risk assessment.

(2) Elimination of Information Disturbing the URL Risk Assessment

In the first embodiment, the information transmitted from the client device 20 at the time of requesting for the URL risk assessment is received by the server device 10, and is stored one after another. However, the present invention is not limited thereto. If a number of the URL risk assessment requests from a predetermined client device 20 in a predetermined period exceeds a predetermined number, the information transmitted from the client device 20 may not be stored in the server device 10.

If a number of the URL risk assessment requests from a predetermined client device 20 in a certain period exceeds a predetermined number, there is a high probability that the requests are sent by an unsolicited email distributor to cause confusion of the information. Therefore, by eliminating the extra information from the information to be stored in the server device 10, the reliability of the URL risk assessment can be maintained. In case of a request sent from a PC or the like connected to the Internet, the client device might be identified due to misrepresentation of the sender email address. Hence, the database (DB) may be updated only upon receiving a request from a client device that can be identified based on authentication by a mobile terminal or the like.

(3) Other Types of Information Used as User Information

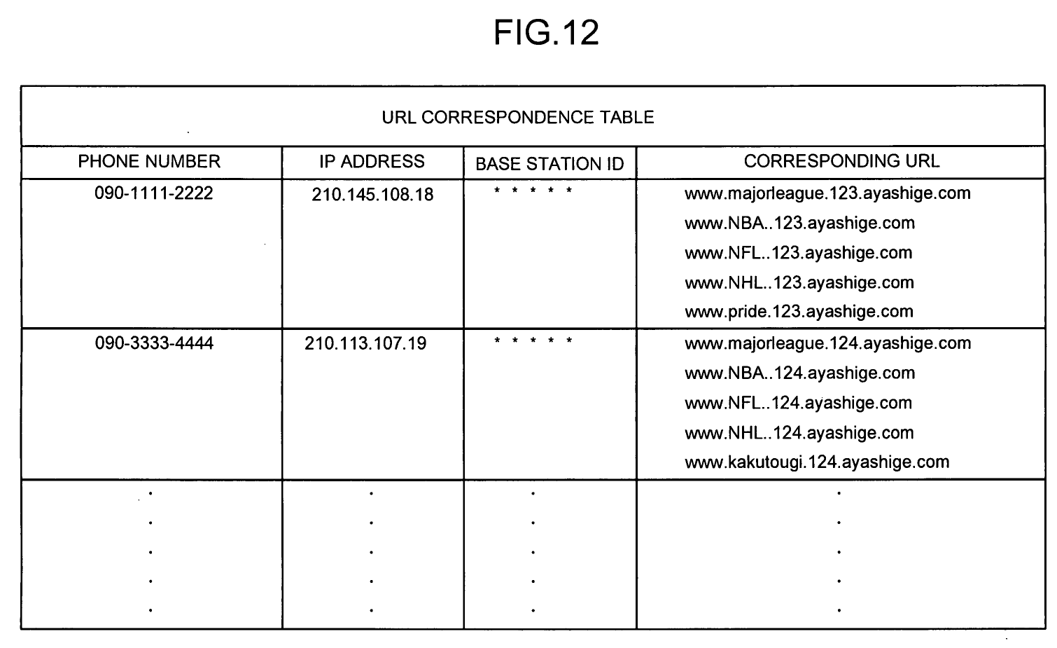

In the first embodiment, an email address of the user using the client device 20 is used as the user information. However, the present invention is not limited thereto, and a phone number, an IP address, and a base station ID can be used. That is, when there is a request for risk assessment to the server device 10 relating to the URL information transmitted from a wicked distributor to the client device 20 (for example, see FIG. 12) corresponding to the phone number, the IP address, and the base station ID, the URL information storage unit 13 stores the information, and the risk assessment processor 15 executes the URL risk assessment based on the information.

Thus, by using the phone number, the IP address, and the base station ID as the user information, the URL risk assessment system can handle wicked distributors who transmit high risk URLs corresponding to the information.

(4) Ex-Post Confirmation of the Safety of URL

In the first embodiment, the server device 10 executes the URL risk assessment in response to a request for URL risk assessment sent by the client device 20. However, the present invention is not limited thereto, and if a URL is assessed as having high risk at the time of risk assessment request, and is confirmed to be safe afterwards, the new assessment result can be notified to the client device 20.

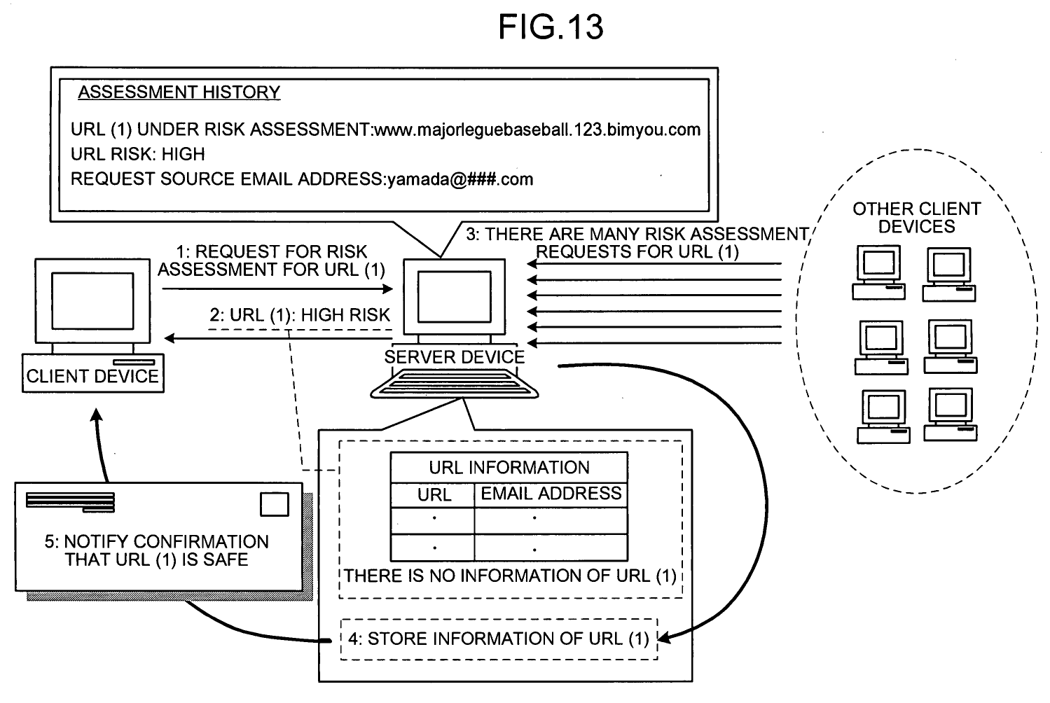

For example, as shown in FIG. 13, there can be a case that the server device 10 assesses that the URL has high risk, at the time of risk assessment request, but after the information of the URL is stored in the server device 10 along with the risk assessment requests from other client devices 20, the server device 10 finds that the URL is safe. Therefore, the server device 10 stores an assessment history in which, the URL for which risk assessment is requested, and the email address of the client device 20 that made the request are stored, and searches the assessment history for the client device 20 that requested the URL risk assessment for the URL, which is found to be safe afterwards. Consequently, when the server device 10 finds the client device 20 that requested for the URL risk assessment in the assessment history, the server device 10 notifies the user of the client device 20 afterwards by an email, that the URL has been confirmed to have no risk.

Thus, when the safety of the URL is confirmed afterwards, the server device 10 notifies this to the user of the client device 20, which has requested for the URL risk assessment, and hence, the convenience of the user who wishes to access the URL is improved accordingly.

(5) URL Risk Assessment Request Unit

In the first embodiment, an email describing information necessary for requesting for the URL risk assessment is automatically created by a mailer function of the client device 20, and the email is automatically transmitted to the server device 10 to request for risk assessment. However, the present invention is not limited thereto, and the risk assessment can be requested automatically by a browser function, or the user can request for the risk assessment manually.

Specifically, when a user instructs to access a URL included in an unsolicited email displayed on the output unit 22 of the client device 20 using the input unit 21, the server device 10 automatically obtains the information of the URL required for the URL risk assessment, the reception date and time of the unsolicited email, and the email address of the client device 20 (see FIG. 9), and accepts the risk assessment request. Furthermore, the user directly accesses the website of the server device 10 from the client device 20, to input information required for the risk assessment in the website to request for the risk assessment.

Thus, because the browser function of the client device is used to request the server device 10 automatically for the risk assessment, the URL risk assessment request simplifies. As a result of simplifying the URL risk assessment request, a number of risk assessment requests further increase, and hence, URL information is stored one after another in the server device 10, thereby improving the reliability of the risk assessment. When the user manually requests for the URL risk assessment, the user can decide whether to perform the URL risk assessment.

(6) Automatic Access to URL

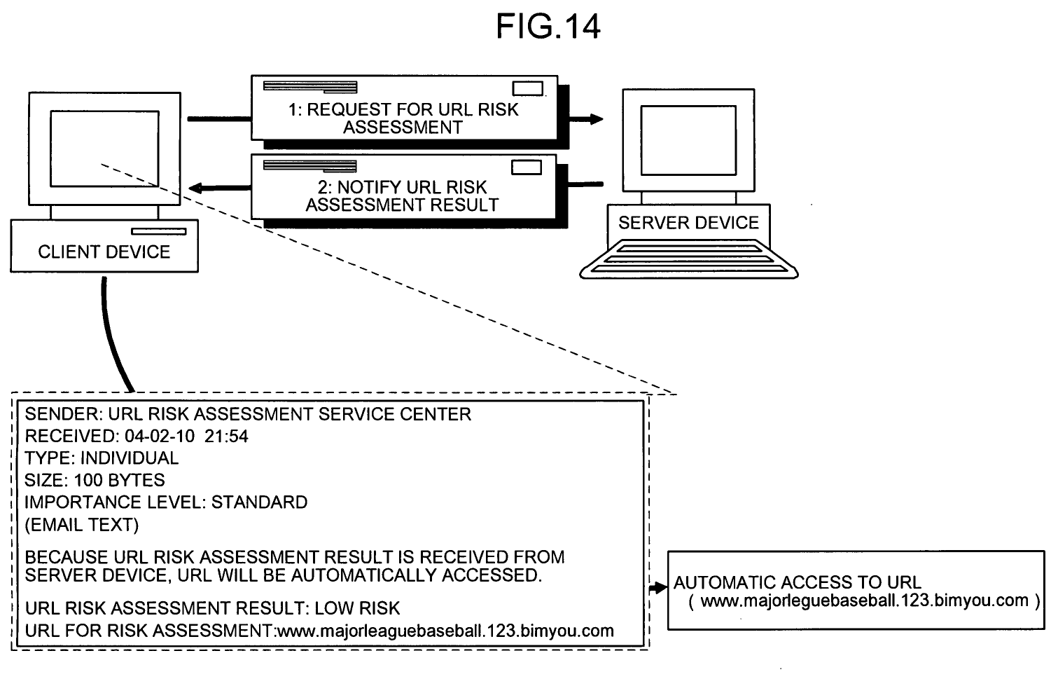

In the first embodiment, the user of the client device 20 determines whether to access the URL based on the URL risk assessment result notified by the server device 10. However, the present invention is not limited thereto. For example, as shown in FIG. 14, when the server device 10 assesses that there is no risk in the URL, to which an access instruction is received from the user, the client device 20 can automatically access the URL upon reception of the risk assessment result.

Because the URL is accessed without waiting for an access instruction from the user of the client device 20 that received the URL risk assessment result, the burden on the user who tries to access the URL can be alleviated.

(7) Omission of URL Risk Assessment Request

In the first embodiment, the URL risk assessment is requested automatically at the time of accessing the URL. However, the present invention is not limited thereto, and if the client device 20 can assess the risk of URL, to which the client device 20 tries to access, the URL risk assessment request to the server device 10 can be omitted.

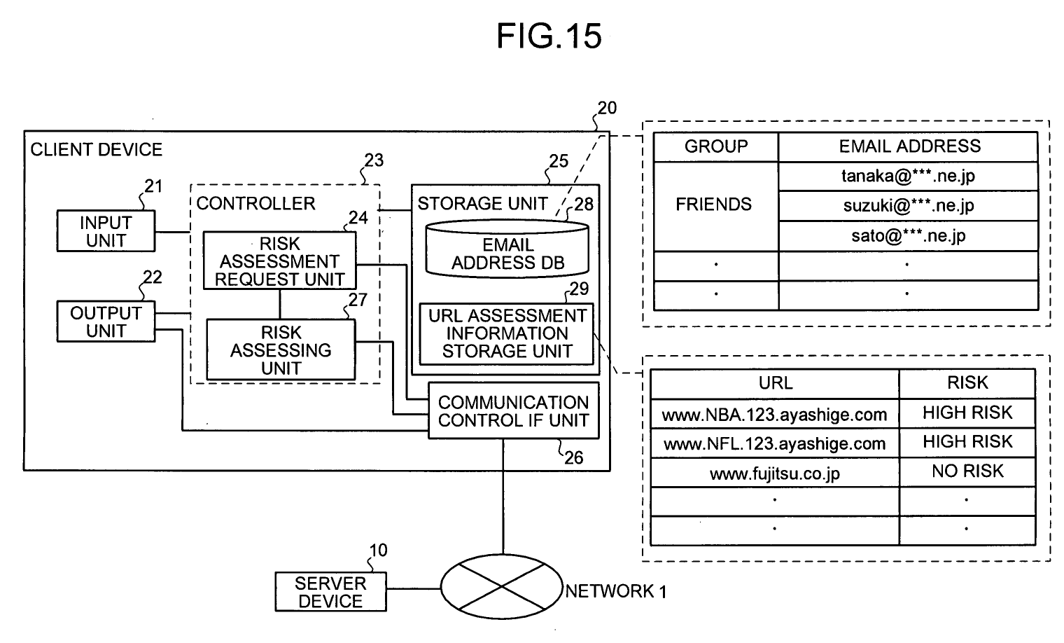

FIG. 15 is a block diagram of the configuration of the client device according to a seventh modification of the second embodiment. As shown in FIG. 15, the client device 20 includes a risk assessing unit 27 in the controller 23, and also an email address DB 28 and a URL assessment information storage unit 29 in the storage unit 25. The email address DB 28 in the storage unit 25 is used for storing email addresses used by the user, and the URL assessment information storage unit 29 stores information for assessing the URL risk. The risk assessing unit 27 in the controller 23 is a processor that assesses the risk of URL included in the email.

For example, the email address DB 28 stores reliable sender email addresses (for example, email addresses of the family, friends, and acquaintances of the user), and the URL assessment information storage unit 29 stores reliable URL information (for example, the whitelist) and information of URL clearly having high risk as a result of assessment by the server device 10 (for example, the blacklist).

The omission of the URL risk assessment request will be explained in detail. The risk assessing unit 27 receives the information in the email including the URL via the communication control IF unit 26, and then reads the information from any one of the email address DB 28 and the URL assessment information storage unit 29 or both, checks the information with the received sender email address and the information of the URL, to assess the risk of the URL. As a result, when the risk of the URL can be assessed, the user of the client device 20 determines whether to access the URL based on the URL risk assessment, without requesting the URL risk assessment to the server device 10.

Examples of cases when the risk of the URL can be assessed may be as follows. When the sender email address is the address of a friend stored in the email address DB 28, the risk assessing unit 27 can assess that the URL does not have any risk. When the URL is stored as the whitelist in the URL assessment information storage unit 29, the risk assessing unit 27 can assess that the URL does not have any risk, and when the URL is stored as the blacklist in the URL assessment information storage unit 29, the risk assessing unit 27 can assess that the URL has high risk.

On the other hand, when the risk of the URL cannot be assessed (for example, when the sender address of the unsolicited email is not stored in the email address DB 28, or the URL is not stored in the URL assessment information storage unit 29), the user of the client device 20 requests for the URL risk assessment to the server device 10.

Thus, when the risk of the URL that the user intends to access can be assessed, the user does not request the server device 10 to assess the risk. Accordingly, unnecessary URL risk assessment request can be omitted, thereby realizing smooth access to the URL.

(8) Utilization of Peer To Peer (P2P)

In the first embodiment, the URL risk assessment system including the server device 10 and the client device 20 has been explained. However, the present invention is not limited thereto, and the URL risk assessment system can include a plurality of client devices 20 connected in a network form of P2P (a network form in which many and unspecified individuals directly exchange information). For example, the client devices 20 are connected in a state that these devices can directly exchange information of the URL (for example, the blacklist and the whitelist) stored in the own client devices. The client devices 20 assess the URL risk respectively based on these pieces of information.

(9) System Configuration

The respective constituents of the respective apparatus in the URL risk assessment system shown in FIG. 4 are only functional divisions, and physically the same configuration is not always necessary. In other words, the specific mode of dispersion and integration of the apparatus is not limited to the illustrated ones, and all or a part thereof may be functionally or physically dispersed or integrated in an optional unit, according to the various kinds of load and the status of use. All or an optional part of the various process functions performed by the apparatus can be realized by a central processing unit (CPU) or a program analyzed and executed by the CPU, or can be realized as hardware by wired logic.

(10) URL Risk Assessment Program

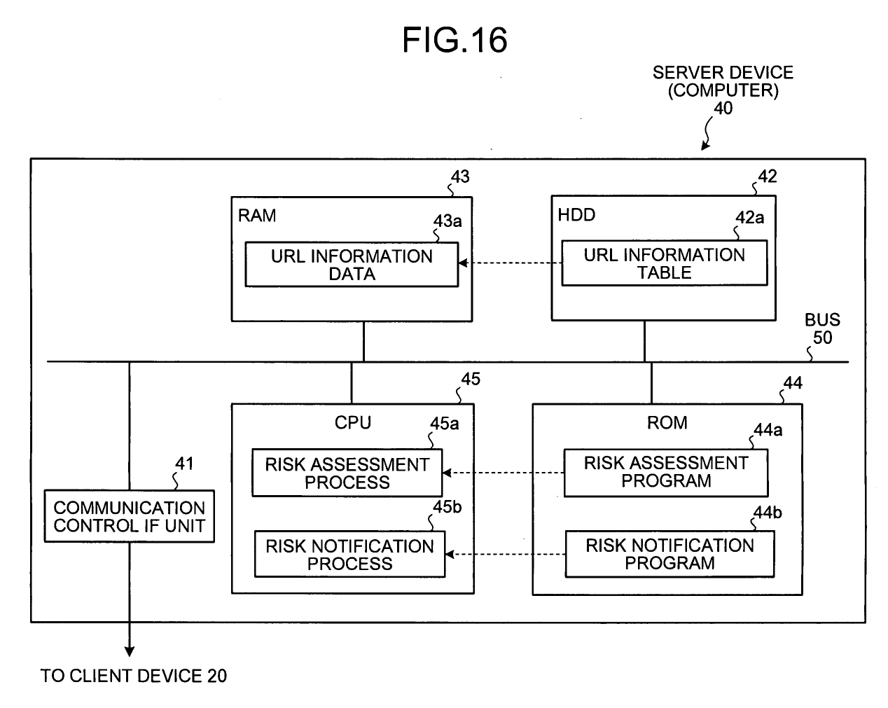

In the above embodiment, various kinds of processes are realized by hardware logic. However, the present invention is not limited thereto, and the various kinds of processes can be realized by executing a program, prepared beforehand, on a computer. An example of a computer that executes a URL risk assessment program having the same function as the server device 10 in the risk assessment system explained in the first embodiment will be explained with reference to FIG. 16. FIG. 16 depicts a computer that executes the URL risk assessment program.

As shown in FIG. 16, a computer 40 (for example, a workstation or a super computer) as the server device in the URL risk assessment system includes a communication control IF unit 41, a hard disk drive (HDD) 42, a random access memory (RAM) 43, a read only memory (ROM) 44, and a CPU 45, all of which are connected by a bus 50 or the like. The communication control IF unit 41 corresponds to the communication control IF unit 11 shown in FIG. 4.

A risk assessment program exhibiting the same function as the server device 10 explained in the above embodiments, that is, as shown in FIG. 16, a risk assessment program 44a and a risk notification program 44b are stored in the ROM 44 beforehand. These programs 44a and 44b can be appropriately integrated or dispersed, like the respective constituents of the server device 10 shown in FIG. 4.

The CPU 45 reads the programs 44a and 44b from the ROM 44 and executes these programs, so that the programs 44a and 44b function as a risk assessment process 45a and a risk notification process 45b, as shown in FIG. 16. The processes 45a and 45b respectively correspond to the risk assessment processor 15 and the risk notifying unit 16 shown in FIG. 4.

As shown in FIG. 16, the HDD 42 includes a URL information table 42a. The URL information table 42a corresponds to the URL information storage unit 13 shown in FIG. 4. The CPU 45 registers the URL information data 43a (more specifically, the URL, the reception date and time and the email address stored in correspondence) in the URL information table 42a, reads and stores the URL information data 43a in the RAM 43, and executes the risk assessment process based on the URL information data 43a stored in the RAM 43.

The programs 44a and 44b are not necessarily stored in the ROM 44 initially. For example, the respective programs can be stored on a “portable physical medium” such as a flexible disk (FD), a CD-ROM, a magneto optical (MO) disk, a digital versatile disk (DVD), an optical magnetic disk, and an integrated circuit (IC) card inserted into the computer 40, or a “fixed physical medium” such as an HDD equipped inside or outside the computer 40, or “another computer (or a server)” connected to the computer 40 via a public line, the Internet, a LAN, or a WAN, and the computer 40 can read the respective programs therefrom and execute the programs.

(11) Risk Assessment Request Program

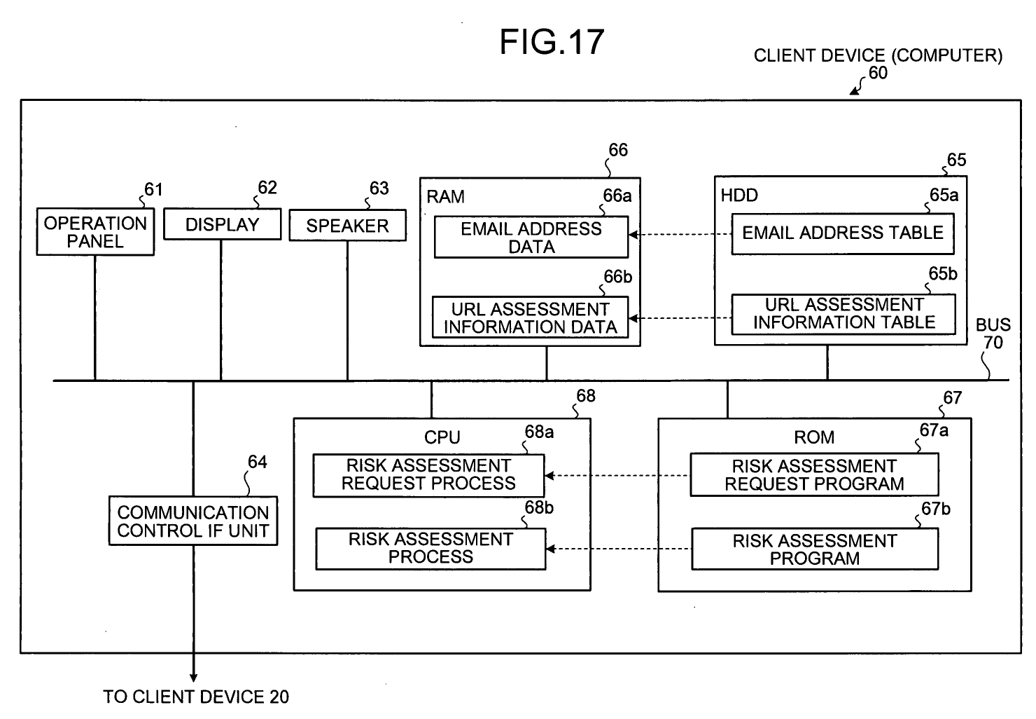

An example of a computer that executes a URL risk assessment request program having the same function as the client device 20 in the URL risk assessment system explained in the first embodiment, as in (10) above, will be explained with reference to FIG. 17. FIG. 17 depicts a computer that executes the URL risk assessment request program.

As shown in FIG. 17, a computer 60 (for example, a mobile phone or a computer) as a client device in the URL risk assessment system includes an operation panel 61, a display 62, a speaker 63, a communication control IF unit 64, an HDD 65, a RAM 66, a ROM 67, and a CPU 68, all of which are connected by a bus 70 or the like. The operation panel 61 corresponds to the input unit 21, the display 62 and the speaker 63 respectively correspond to the output unit 22, and the communication control IF unit 64 corresponds to the communication control IF unit 26 shown in FIG. 15.

A risk assessment request program exhibiting the same function as the client device 20 explained in the above embodiments, that is, as shown in FIG. 17, a risk assessment request program 67a and a risk assessment program 67b are stored in the ROM 67 beforehand. The programs 67a and 67b can be appropriately integrated or dispersed like the respective constituents of the client device 20 shown in FIG. 15.

The CPU 68 reads the programs 67a and 67b from the ROM 67 and executes these programs, so that the programs 67a and 67b function as a risk assessment request process 68a and a risk assessment process 68b, as shown in FIG. 17. The processes 68a and 68b respectively correspond to the risk assessment request unit 24 and the risk assessing unit 27 shown in FIG. 15.

As shown in FIG. 17, an email address table 65a and a URL assessment information table 65b are provided in the HDD 65. The email address table 65a and the URL assessment information table 65b respectively correspond to the email address DB and the URL assessment information storage unit shown in FIG. 15. The CPU 68 reads email address data 66a and URL assessment information data 66b from the email address table 65a and the URL assessment information table 65b, respectively, stores these data in the RAM 66, and executes the risk assessment process and the risk assessment request process based on the email address data 66a and the URL assessment information data 66b stored in the RAM 66.

The programs 67a and 67b are not necessarily stored in the ROM 67 initially. For example, these programs can be stored on a “portable physical medium” such as an FD, a CD-ROM, an MO disk, a DVD disk, a magneto-optical disk, and an IC card inserted into the computer 60, a “fixed physical medium” such as an HDD equipped inside or outside the computer 60, or “another computer (or a server)” connected to the computer 60 via a public line, the Internet, a LAN, or a WAN, and the computer 60 can read the programs therefrom and execute the programs.

According to an aspect of the present invention, the distributors of unsolicited emails are prevented from obtaining personal information of a user, such as the validity of the email address, interests, and time of accessing the Internet.

Moreover, the URL risk assessment system can be realized without storing the URL information separately in the server device.

Furthermore, the user is prevented from inadvertently accessing the URL.

Moreover, reliability and speed of the URL risk assessment is enhanced.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A URL risk assessment system that assesses a risk of a URL included in an email that is received by a client device, comprising:
a URL information storage unit that stores the URL in correspondence with user information, wherein the user information identifies any one of the client device that received the email, and the user that received the email; and
a URL risk assessing unit that assesses the risk of the URL based on whether other client devices have received the same URL, by referring to the user information stored.

2. The URL risk assessment system according to claim 1, wherein
the URL risk assessing unit assesses the risk of the URL based on whether a number of client devices that received the same URL, other than the client device having received the email, is at least equal to a predetermined number.

3. The URL risk assessment system according to claim 1, wherein
the URL information storage unit further stores a reception date and time of the email, and
the URL risk assessing unit assesses the risk of the URL based on whether other client devices received the same URL within a predetermined period, by referring to the reception date and time of the URL included in the email.

4. The URL risk assessment system according to claim 1, wherein
the URL information storage unit further stores at least one of high risk URLs and URLs having no risk, and
the URL risk assessing unit assesses the risk of the URL by preferentially referring to the URLs stored.

5. The URL risk assessment system according to claim 1, wherein
the URL information storage unit stores an email address, a phone number, an IP address, and a base station ID as the user information.

6. A URL risk assessment system comprising:
a client device; and
a server device that assesses a risk of a URL included in an email received by a client device, wherein
the client device includes a URL risk assessment requesting unit that sends a request to perform the URL risk assessment, and the URL included in the email, to the server device, and
the server device includes
a URL information storage unit that stores the URL for which a request for risk assessment is received, in correspondence with the user information for identifying the client device that sent the request,
a URL risk assessing unit that assesses the risk of the URL based on whether other client devices have received a same URL, identical to the URL for which the request for risk assessment is received, by referring to the user information stored, and
a URL risk notifying unit that notifies the client device of a URL risk assessment result.

7. The URL risk assessment system according to claim 6, wherein
the URL risk assessing unit assesses the risk of the URL based on whether a number of client devices that received the same URL, other than the client device having received the email, is at least equal to a predetermined number.

8. The URL risk assessment system according to claim 6, wherein
the URL information storage unit further stores a reception date and time of the email, and
the URL risk assessing unit assesses the risk of the URL based on whether other client devices received the same URL within a predetermined period, by referring to the reception date and time of the URL included in the email.

9. The URL risk assessment system according to claim 6, wherein
the URL information storage unit further stores at least one of high risk URLs and URLs having no risk, and
the URL risk assessing unit assesses the risk of the URL by preferentially referring to the URLs stored.

10. The URL risk assessment system according to claim 6, wherein
if a number of the requests for URL risk assessment from predetermined client devices within a certain period is more than a predetermined number, the URL information storage unit does not store the URL and the user information.

11. The URL risk assessment system according to claim 6, wherein
the URL information storage unit stores an email address, a phone number, an IP address, and a base station ID as the user information.

12. The URL risk assessment system according to claim 6, wherein
the client device receives notification that a predetermined URL is of high risk, and
the server device further comprises:
a URL safety confirmation notifying unit that notifies the client device of safety of the predetermined URL, if the safety of the predetermined URL is confirmed after storing the predetermined URL in the URL information storage unit.

13. The URL risk assessment system according to claim 6, wherein
the URL risk assessment request unit in the client device requests for URL risk assessment to the server device via a browser function, when an access to the URL included in the email is instructed.

14. The URL risk assessment system according to claim 6, wherein the client device further comprises:
a URL accessing unit that accesses the URL, if the URL risk assessment result notified by the server device indicates safety of the URL.

15. The URL risk assessment system according to claim 6, wherein the client device further comprises:
a URL assessment information storage unit that stores risk assessment information for at least one of a predetermined sender email address and a predetermined URL, and
the URL risk assessment request unit refers to the risk assessment information stored in the URL assessment information storage unit, and requests for URL risk assessment to the server device, if the risk of any one of the sender's email address and the URL included in the email is unknown.

16. A method for assessing a risk of a URL included in an email that is received by a client device, comprising:
storing the URL in correspondence with user information, wherein the user information identifies any one of the client device that received the email, and the user that received the email; and
assessing the risk of the URL based on whether other client devices have received the same URL, by referring to the user information stored.

17. A computer-readable recording medium that stores therein, a computer program for assessing a risk of a URL included in an email that is received by a client device, the computer program including instructions, which when executed, cause the computer to execute:
storing the URL in correspondence with user information, wherein the user information identifies any one of the client device that received the email, and the user that received the email; and
assessing the risk of the URL based on whether other client devices have received the same URL, by referring to the user information stored.

18. A method of URL risk assessment in which a server device assesses a risk of a URL included in an email received by a client device, comprising:
sending, from the client device to the server device, a request to perform the URL risk assessment, and the URL included in the email;
storing, in the server device, the URL for which a request for the URL risk assessment is received, in correspondence with the user information for identifying the client device that sent the request;
assessing the risk of the URL based on whether other client devices have received a URL identical to the URL for which the request for risk assessment is received, by referring to the user information stored at the storing, wherein the assessing is executed by the server device; and
notifying the client device of a URL risk assessment result, the notifying being executed by the server device.

19. A computer-readable recording medium that stores therein, a computer program for performing URL risk assessment in which a server device assesses a risk of a URL included in an email received by a client device, the computer program including instructions, which when executed, cause the computer to execute:
sending, from the client device to the server device, a request to perform the URL risk assessment, and the URL included in the email;
storing, in the server device, the URL for which a request for the URL risk assessment is received, in correspondence with the user information for identifying the client device that sent the request;
assessing the risk of the URL based on whether other client devices have received a URL identical to the URL for which the request for risk assessment is received, by referring to the user information stored at the storing, wherein the assessing is executed by the server device; and
notifying the client device of a URL risk assessment result, the notifying being executed by the server device.
